(19) United States
(12) Patent Application Publication
(10) Pub. No.: US 2012/0207282 A1
(43) Pub. Date: Aug. 16, 2012

(54) X-RAY IMAGING APPARATUS

(75) Inventors: Yasunori GOTO, Shioya-gun (JP); Hiroaki Sato, Nasushiobara-shi (JP)

(73) Assignees: TOSHIBA MEDICAL SYSTEMS CORPORATION, Otawara-shi (JP); Kabushiki Kaisha Toshiba, Minato-ku (JP)

(21) Appl. No.: 13/363,510

(22) Filed: Feb. 1, 2012

(30) Foreign Application Priority Data
Feb. 15, 2011 (JP) 2011-029657

(51) Int. Cl. H05G 1/02

(52) U.S. Cl. 378/197

(57) ABSTRACT

An X-ray imaging apparatus according to one embodiment of the present invention includes: an arm unit holding an X-ray tube unit that generates an X-ray and an X-ray detection unit that detects the X-ray generated by the X-ray tube unit; a column unit rotatably supporting the arm unit; a holding unit holding the column unit at a floor surface; an inclining unit inclining the column unit with the holding unit as a rotation center axis thereof; and a controller performing control, when the column unit is inclined by the inclining unit, to horizontally move the X-ray tube unit and X-ray detection unit while maintaining the relative distance and relative angle therebetween.

### CROSS-REFERENCE TO RELATED APPLICATION

This application is based upon the benefit of priority from the Japanese Patent Application No 2011-029657, filed on Feb. 15, 2011, the entire contents of which are incorporated herein by reference.

### FIELD

The present invention relates to an X-ray imaging apparatus.

### BACKGROUND

An X-ray imaging apparatus having a universal stand capable of performing general radiography with one FPD (Flat Panel Detector) is designed for general-purpose radiography, and, by changing the position (attitude) of the universal stand, it can perform radiography of various parts of body such as chest, abdomen, and extremities in various body positions such as a recumbent position while changing radiographic direction, thus achieving smaller size and cost. It is currently demanded that an FPD allowing real-time fluoroscopic radiography is mounted so as to perform endoscopic inspection while viewing a radiographic image.

However, a conventional universal stand cannot be moved in the longitudinal direction (body axis direction of a patient) at the time when a patient in a recumbent position is radiographed. Thus, in order to move the radiography position, a recumbent table (stretcher, etc.) on which the patent lies or patient him or herself needs to be moved. Especially, in the case where the X-ray imaging apparatus is used for non-IVR (Interventional radiography) such as endoscopic inspection as a fluoroscopy, movement of the radiography position in the longitudinal direction of the recumbent patient is often required. Since it is very dangerous to move the patient in a state where an endoscope has been inserted into the patient's body, the endoscope needs to be removed from the patient's body before he or she is moved. This causes suffering to the patient and interferes with prompt diagnosis.

There is known, as a system for coping with the above problem, a system in which an imaging unit is hung from the ceiling or a system in which a guide rail is laid on the floor; however, in this case, the entire system size including the ceiling part or floor part is increased to narrow the space for other medical instruments, resulting in loss of mobility of medical staff due to lack of accessibility, workability, or sufficient space and in an increase in the total system cost (including the installation cost).

Embodiments of the present invention provide a small and high-performance X-ray imaging apparatus having a horizontally movable universal stand.

### BRIEF DESCRIPTION OF THE DRAWINGS

FIG. 1 is a block configuration diagram of an X-ray imaging apparatus according to a first embodiment;

FIG. 2 is a configuration diagram of a universal stand in the first embodiment;

FIGS. 3A and 3B are explanatory views each illustrating horizontal movement of the universal stand in the first embodiment;

FIG. 4 is a flowchart illustrating the horizontal movement of the universal stand in the first embodiment;

FIGS. 5A and 5B are explanatory views each illustrating oblique incidence radiography of the X-ray imaging apparatus according to a second embodiment;

FIG. 6 illustrates an example of an operation panel of a stand operation unit in a third embodiment;

FIGS. 7A to 7E illustrate an example of operation for moving an arm of the universal stand in the third embodiment;

FIGS. 8A and 8B illustrate an example of operation for rotating a tube of the universal stand in the third embodiment;

FIGS. 9A and 9B illustrate an example of operation for rotating an FPD of the universal stand in the third embodiment;

FIG. 10 illustrates an example of operation for achieving reset operation of the universal stand in the third embodiment;

FIGS. 11A to 11C illustrate an example of operation for achieving SID operation of the universal stand in the third embodiment;

FIGS. 12A to 12C illustrate an example of operation for horizontally moving the universal stand in the third embodiment; and

FIGS. 13A and 13B are explanatory views illustrating column inclination of a ceiling-mount type universal stand in a fourth embodiment;

FIGS. 14A and 14B are explanatory views illustrating column retraction of the universal stand in the fourth embodiment.

### DETAILED DESCRIPTION

According to one embodiment of the present invention, there is provided an X-ray imaging apparatus including: an arm unit holding an X-ray tube unit that generates an X-ray and an X-ray detection unit that detects the X-ray generated by the X-ray tube unit; a column unit rotatably supporting the arm unit; a holding unit holding the column unit at a floor surface; an inclining unit inclining the column unit with the holding unit as a rotation center axis thereof; and a controller performing control, when the column unit is inclined by the inclining unit, to horizontally move the X-ray tube unit and X-ray detection unit while maintaining the relative distance and relative angle therebetween.

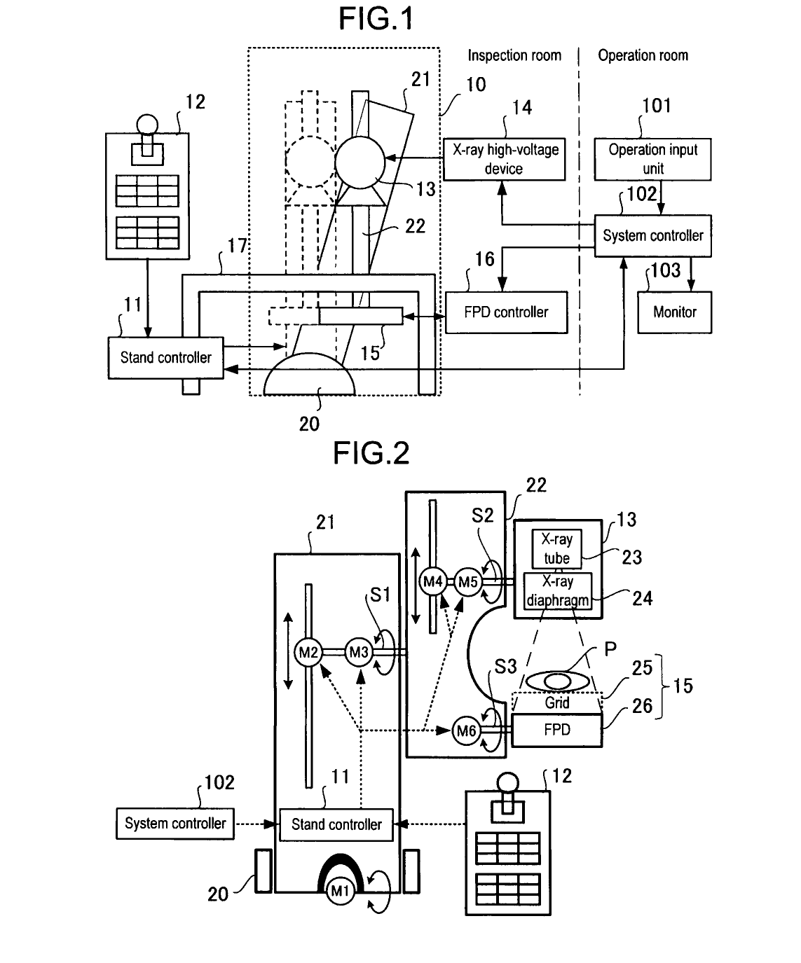

The following describes in detail embodiments for practicing the present invention with reference to FIGS. 1 to 14.

### First Embodiment

FIG. 1 illustrates an X-ray imaging apparatus according to a first embodiment. The X-ray imaging apparatus of the present embodiment includes, on an inspection room side thereof, a universal stand 10 having an inclining unit, a stand controller 11 that controls a universal stand 10, a stand operation unit 12 that operates the universal stand 10, an X-ray high-voltage device 14 that applies a high voltage to an X-ray tube unit 13 provided in the universal stand 10, and an FPD controller 16 that controls an X-ray detection unit 15 provided in the universal stand 10 and acquires an medical image of a subject from the X-ray detection unit 15. A table 17 for radiography of the subject is installed between the X-ray tube unit 13 and X-ray detection unit 15. In FIG. 1, the universal stand 10 is viewed from the front.

The X-ray imaging apparatus includes, on an operation room side thereof, an operation input unit 101 connected with a hand switch for controlling the X-ray high-voltage device 14 and a user interface such as a mouse or a keyboard for inputting a radiography condition and operation information, a system controller 102 that integrally controls the entire X-ray imaging apparatus so as to acquire the medical image based on the radiography condition, and a monitor 103 that is connected to the system controller 102 and displays the medical image acquired from the X-ray detection unit 15.

The universal stand 10 of the X-ray imaging apparatus of the present embodiment denoted by a dotted line is installed on the floor surface, and a column 21 can be inclined (rotated) with the inclining unit 20 as the rotation center. The inclining unit 20 has a not illustrated holding unit. Fixing of this holding unit onto the floor surface by means of mechanical parts such as screws allows the column 21 to be inclined with respect to the holding unit. The inclination of the column 21 allows the position of an arm 22 holding the X-ray detection unit 15 opposite to the X-ray tube unit 13 to be moved in the horizontal direction.

FIG. 2 is a configuration diagram of the universal stand 10. For easy understanding of a mechanism configuration, the universal stand 10 is viewed from the side. As illustrated in FIG. 1, the universal stand 10 includes the column 21 having the inclining unit 20, arm 22 supported by the column 21, X-ray tube unit 13 mounted to the arm 22, and X-ray detection unit 15 mounted to the arm 22 in such a manner as to be opposed to the X-ray tube unit 13. In this example, a subject P lies between the X-ray tube unit 13 and X-ray detection unit 15. In FIG. 2, the table 17 is omitted.

The X-ray tube unit 13 has an X-ray tube 23 that generates an X-ray and an X-ray diaphragm 24 for adjusting an X-ray irradiation field. The X-ray detection unit 15 has a grid 25 which is used as needed for removing scattered X-rays and improving the contrast. Parts to be radiographed that require the grid 25 are a chest, abdomen, hip, pelvis, etc., of an adult. Parts to be radiographed that do not generally require the grid 25 are the nasal bone, teeth, limb bones (excluding the hip joint), hip joint of an infant. An FPD 26 is a flat panel detector that uses a semiconductor sensor to obtain a radiographic image. More specifically, the FPD 26 has a structure in which photoelectric conversion elements are arranged in a two-dimensional lattice on a flat substrate and can obtain an output image (fluoroscopic or radiographic image of the subject P) instantaneously.

The inclining unit 20 is constructed of a motor M1 having a rotation mechanism and can incline the column 21. The column 21 has a motor M2 for linearly moving the arm 22 along the longitudinal direction thereof and a motor M3 for rotating the arm 22 about an arm support point S1.

The arm 22 has a motor M4 for linearly moving the X-ray tube unit 13 along the longitudinal direction thereof and a motor M5 for rotating the X-ray tube unit 13 about a support point S2. The arm 22 further has a motor M6 for rotating the X-ray detection unit 15 about a support point S3 supporting the X-ray detection unit 15.

The arm 22 has a bending portion like “C” between the X-ray tube unit 13 and X-ray detection unit 15. This creates a space between the subject P and arm 22, preventing various positions to be diagnosed from being restricted by the arm 22.

The stand controller 11 that controls the attitude of the universal stand 10 may be provided inside the universal stand 10, and the stand operation unit 12 is used to operate the stand controller 11 by wired or wireless to thereby achieve attitude control of the universal stand 10. The attitude control can be performed through the system controller 102.

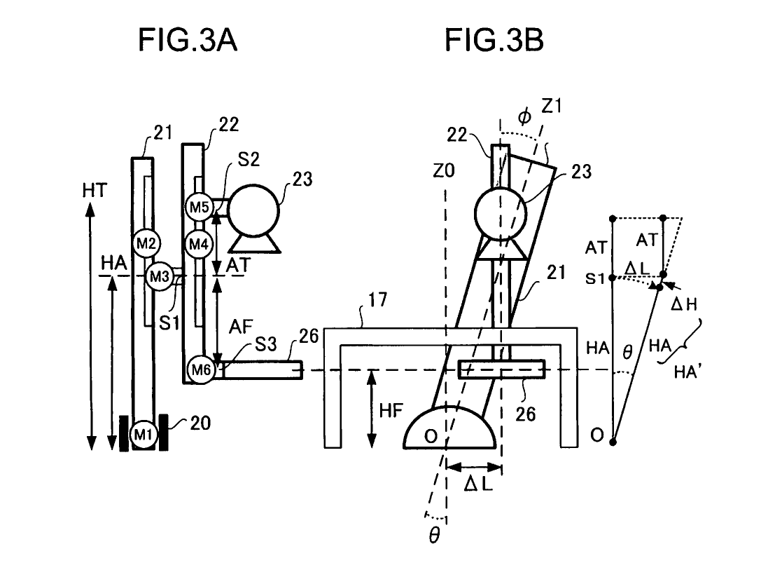

FIGS. 3A and 3B are explanatory views illustrating horizontal movement of the universal stand 10. The following describes especially the attitude control for horizontally moving the radiography position in the longitudinal direction of the recumbent subject (body axis direction of the subject P) in the case where the X-ray imaging apparatus of the present embodiment is used for non-IVR (Interventional radiography) such as endoscopic inspection as a fluoroscopic radiography apparatus. FIG. 3A is a side view of the universal stand 10, and FIG. 3B is a front view of the universal stand 10.

The control of horizontal movement in the longitudinal direction of the recumbent subject needs to be accomplished without changing the relative position between the X-ray tube unit 13 and X-ray detection unit 15. Thus, the horizontal movement is performed while controlling the height direction so as not to allow the height positions of the X-ray tube 23 and FPD 26 to be changed by the inclination of the column 21.

In FIG. 3A, the height before horizontal movement from an original point O of the inclining unit 20 to X-ray tube 23 is HT, distance between the original point O and support point S1 of the arm 22 is HA, distance between the X-ray tube 23 and support point S1 of the arm 22 is AT, and distance between the support point S1 and FPD 26 is AF.

In FIG. 3B, a case where the universal stand 10 is horizontally moved by ΔL in the longitudinal direction of the recumbent subject is assumed. In this case, assuming that the inclined angle of the column 21 is θ, travel distance of the arm 22 in the longitudinal direction of the column 21 is ΔH, angle formed by the arm 22 and column 21 is φ, the following horizontal movement control expressions with respect to the longitudinal direction of the recumbent patient are obtained.

HT=HA+AT (1)

HF=HA−AF (2)

θ=tan⁻¹(ΔL/HA) (3)

φ=θ (4)

ΔH=HA·(1/cos θ−1) (5)

The travel distance ΔH in expression (5) can be calculated from the distance HA′ (expression (6)) after horizontal attitude control between the original point O of the inclining unit 20 and support point S1 of the arm 21.

HA′=HA+ΔH=HA/cos θ (6)

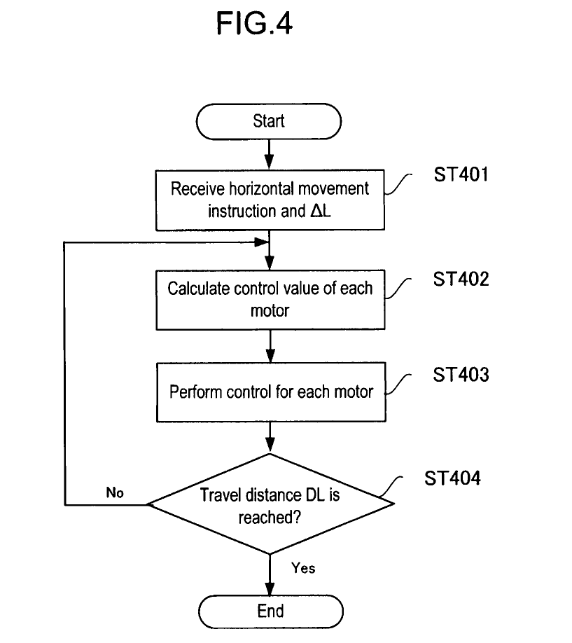

FIG. 4 illustrates a flowchart of the horizontal attitude control in the longitudinal direction of the recumbent subject executed by the stand controller 11 using the above expressions (1) to (6).

In step ST401, a doctor or a laboratory technician continues to depress or depresses more than once a horizontal movement button provided in the stand operation unit 12 so that the universal stand 10 is moved by a required travel distance DL in the longitudinal direction of the recumbent subject. The details of the stand operation unit 12 will be described later in a third embodiment. Upon depression of the horizontal movement button in the longitudinal direction of the recumbent subject, the stand controller 11 receives a horizontal movement instruction and performs the horizontal attitude control with a predetermined resolution ΔL (minimum travel distance determined by a setting condition of the apparatus) set as a unit of control.

In step ST402, after receiving the horizontal movement instruction, the stand controller 102 acquires a current controlling value of each of the motors M1 to M6 and then calculates controlling values of the motors M1 to M6 with respect to the resolution ΔL. That is, in the case of the horizontal movement, the distance (hereinafter, referred to as “SID” (Source-Image Distance)) between the X-ray tube 23 and FPD 26 needs to be kept constant.

That is, if the SID changes, image magnifications will change. Moreover, the grid 25 capable of removing scattered X-rays transmitted through the subject P has a structure in which lead plates or the like each having a high X-ray absorption are arranged with aluminum or paper having a low X-ray absorption interposed therebetween and has convergence characteristics so as to make each lead plate be directed to the focal point in order that only the X-ray from a predetermined focal position is transmitted through the interval between the lead plates. Thus, the actual value range of the SID is previously determined according to the grid suitably used for a part to be radiographed. Therefore, in FIG. 3, since the values of AT and AF are kept constant, the motor M4 holds its current controlling value. For the motor M1, θ corresponding to ΔL is calculated from expression (3). For the motor M2, the controlling value is calculated so that HA′ is derived from expression (6). For the motor M3, φ is set to θ. The controlling angles of the motors M5 and M6 are both set to 0° because the X-ray tube 23 and FPD 26 are arranged opposed to each other in the vertical direction.

In step ST403, the motors M1 to M6 are controlled based on the controlling values calculated in step ST402. When ΔL is sufficiently small, the order of the control operation can be ignored; while when ΔL is large, in order to prevent contact with the table 17, the finer control is required or the order of the control operation for the motors needs to be taken into consideration (for example, the motor M1 of the inclining unit 20 and motor M3 for rotating the arm 22 are controlled at the same time, and then the motor M2 is controlled).

In step ST404, the doctor or laboratory technician determines whether the horizontal travel distance DL specified using the stand operation unit 12 is reached. When the horizontal travel distance DL is not reached (No in step ST404), the flow returns to step ST402 and the control according to ΔL is repeated until the horizontal travel distance DL is reached. When the horizontal travel distance DL is reached (Yes in step ST404), the control is ended. In this manner, it is possible to accomplish the horizontal movement in the longitudinal direction of the recumbent subject without changing the SID between the X-ray tube 23 and FPD 26.

As described above, according to the first embodiment, the horizontal movement in the longitudinal direction of the recumbent subject can be achieved in the X-ray imaging apparatus having the universal stand. As a result, adequate imaging positioning can be achieved without the need to move the subject or table at the time when the subject in a recumbent position is radiographed, thereby significantly reducing the danger to the patient and burden thereon. Especially, in the case where the universal stand having a fluoroscopic imaging function is used for endoscopic inspection or the like, there is no need to move the subject in a state where the endoscope is inserted into his or her body, contributing particularly to removal of the danger.

### Second Embodiment

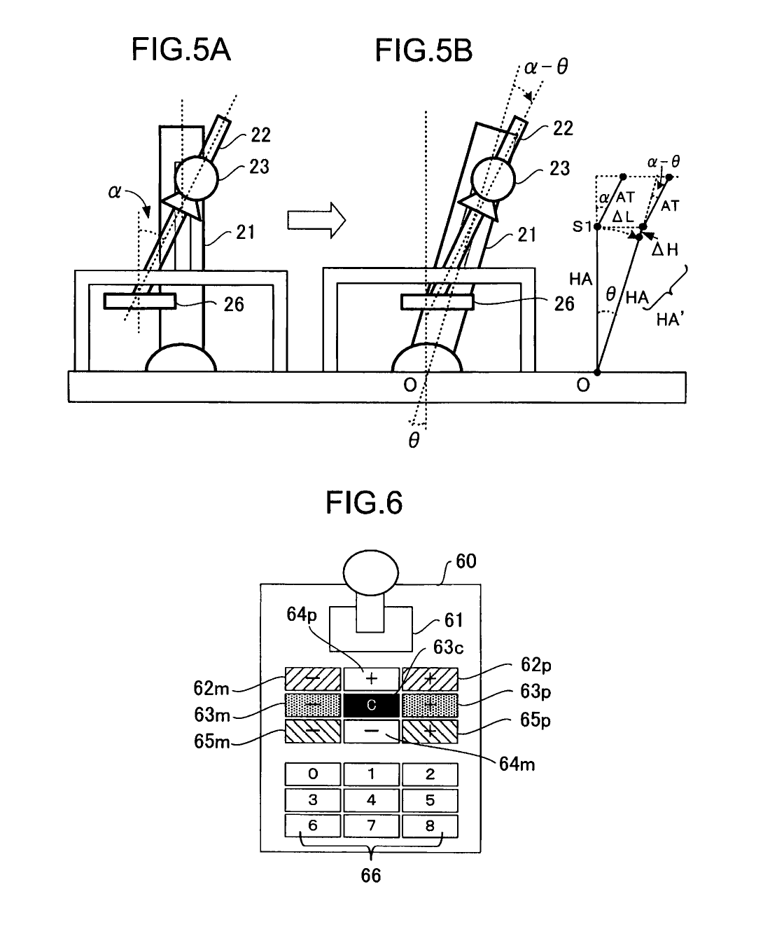

A second embodiment enables the horizontal movement in the longitudinal direction of the recumbent subject even at the time of oblique incidence radiography as illustrated in FIGS. 5A and 5B. FIG. 5A illustrates an attitude of the universal stand 10 before horizontal movement, and FIG. 5B illustrates that after horizontal movement.

In FIG. 5A, the arm 22 is inclined relative to the column 21 by an angle α, and an X-ray emitted from the X-ray tube 23 is obliquely irradiated to the subject P. In this case, the angle formed by the X-ray tube 23 and arm 22 is 0°, and angle formed by the FPD 26 and arm 22 is α. The other parameters are set to the same values as those in FIGS. 3A and 3B.

FIG. 5B illustrates a state where the universal stand 10 is horizontally moved from the state of FIG. 5A without changing the relative positional relationship between the X-ray tube 23 and FPD 26, that is, without changing the angle between the X-ray tube 23 and FPD 26 relative to the longitudinal direction of the arm 22 and distance (SID) between them.

In order to enable the horizontal movement in the longitudinal direction of the recumbent subject in the oblique incidence radiography, the angle between the arm 22 and column 21 is required to be α-θ assuming that the inclination angle of the inclining unit 20 (column 21) is θ. The inclination of the inclining unit 20 lowers the height position of the X-ray tube 23, thus requiring a correction of the height position. In this case, the correction amount is represented by ΔH as in the case of the first embodiment.

Thus, for the motor M1, θ corresponding to ΔL is calculated from expression (3). For the motor M2, the controlling value is calculated so that HA′ is derived from expression (6). For the motor M3, φ is set to α-θ. For the motor M4, the current control value is held. For the motors M5 and M6, the controlling angles before horizontal movement illustrated in FIG. 5A are held.

As described above, according to the second embodiment, in addition to the effects of the first embodiment, the horizontal movement in the longitudinal direction of the recumbent subject while keeping the relative angle between the X-ray tube and FPD even in the case where the radiography is performed with the X-ray obliquely irradiated to the subject P.

### Third Embodiment

A third embodiment describes the stand operation unit 12 configured to be remotely operated so as for the doctor to easily move the universal stand 10 even while performing endoscopic inspection using the FPD 26 having a fluoroscopic imaging function and to acquire a desired fluoroscopic image.

FIG. 6 illustrates an example of an operation panel 60 constituting the stand operation unit 12. The stand operation unit 12 is connected to the stand controller 11 through the operation panel 60 and a wired or a wireless means. The wireless means is easier to handle due to absence of wiring; however, it is necessary to use a radio frequency band less affecting the subject or medical instruments and to pay attention to the output level thereof.

The operation panel 60 has a joystick 61 for controlling the attitude of the universal stand 10, attitude control buttons 62 to 65, and a preset button group 66.

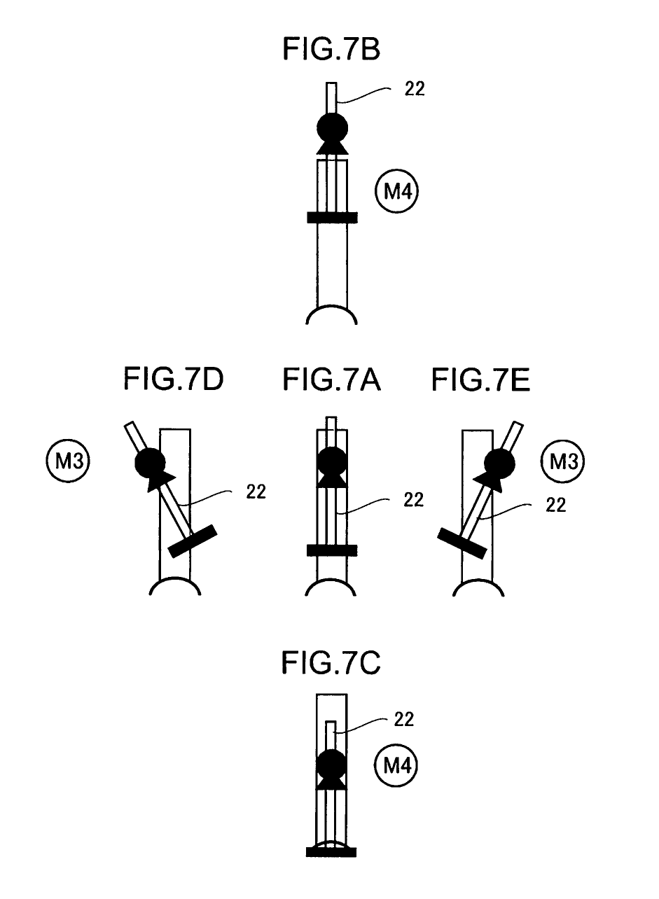

The joystick 61 enables elevation and rotation of the arm 22. As illustrated in FIGS. 7A to 7E, when the joystick 61 is inclined upward, the arm 22 is elevated as illustrated in FIGS. 7A and 7B. When the joystick 61 is inclined downward, the arm 22 is descended as illustrated in FIG. 7C. When the joystick 61 is inclined to the left, the arm 22 starts to rotate counterclockwise as illustrated in FIG. 7D. When the joystick 61 is inclined to the right, the arm 22 starts to rotate clockwise as illustrated in FIG. 7E. The elevation, descent, or rotation is continued during the inclination of the joystick and, at the time point when a desired travel distance or rotation angle is reached, the joystick is returned to its original position. In this joystick operation, the stand controller 11 controls the motors M3 and M4.

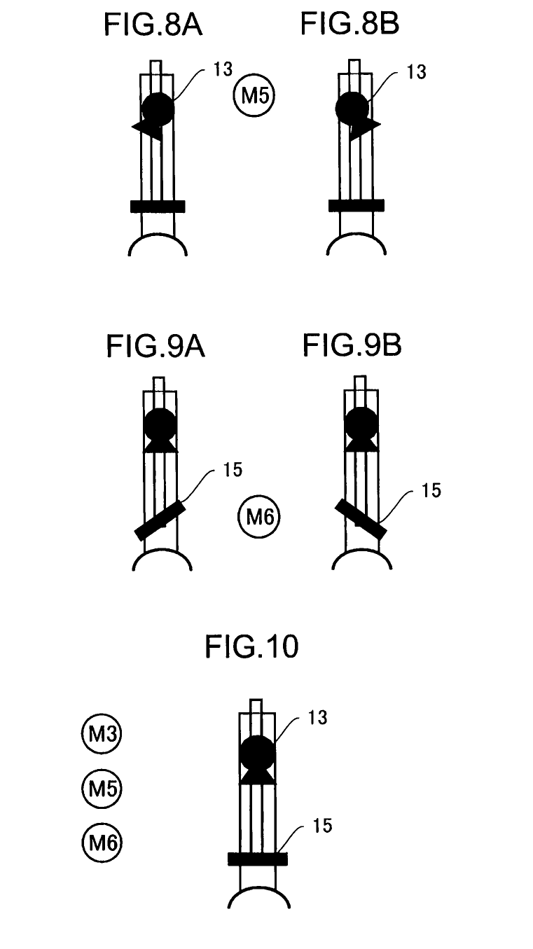

The following describes the attitude control buttons 62 to 65 illustrated in FIG. 6 with reference to FIGS. 8 to 12. Attitude control buttons 62p and 62m are buttons for rotating the X-ray tube unit 13. When the button 62m is depressed, the X-ray tube unit 13 starts to rotate to the left (clockwise) as illustrated in FIG. 8A. When the button 62p is depressed, the X-ray tube unit 13 starts to rotate to the right (counterclockwise) as illustrated in FIG. 8B. The depression of the buttons 62p and 62m causes the stand controller 11 to control the motor M5.

The attitude control buttons 63p and 63m are buttons for rotating the X-ray detection unit 15. When the button 63m is depressed, the X-ray detection unit 15 starts to rotate counterclockwise as illustrated in FIG. 9A. When the button 63p is depressed, the X-ray detection unit 15 starts to rotate clockwise as illustrated in FIG. 9B. The depression of the buttons 63p and 63m causes the stand controller 11 to control the motor M6.

When the button 63c is depressed, the rotation of the X-ray tube unit 13 and X-ray detection unit 15 is canceled and the X-ray tube unit 13 and FPD 26 are reset to the positions where they are vertically opposed to each other with respect to the arm 22, as illustrated in FIG. 10. If the arm 22 is inclined, the depression of the button 63c may reset the arm 22 to its original position (upright position).

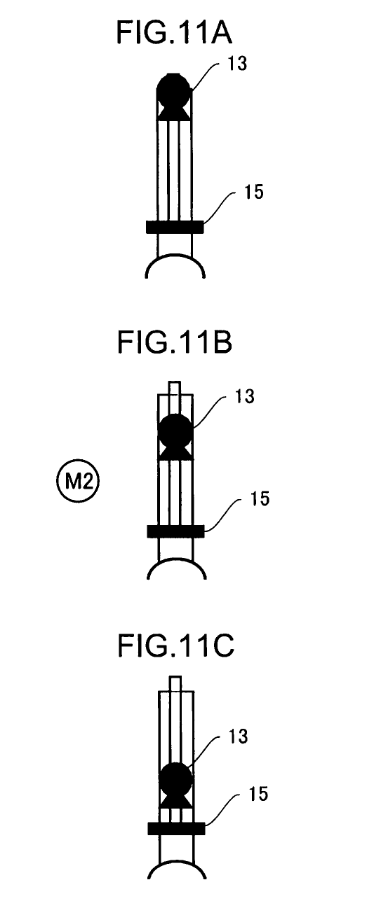

The attitude control buttons 64p and 64m are buttons for adjusting the distance, i.e., SID between the X-ray tube unit 13 and X-ray detection unit 15. When the button 64p is depressed, the SID is made larger in FIG. 11A than that in FIG. 11B. When the button 64m is depressed, the SID is made smaller as illustrated in FIG. 11C. The depression of the buttons 64p and 64m causes the stand controller 11 to control the motor M2.

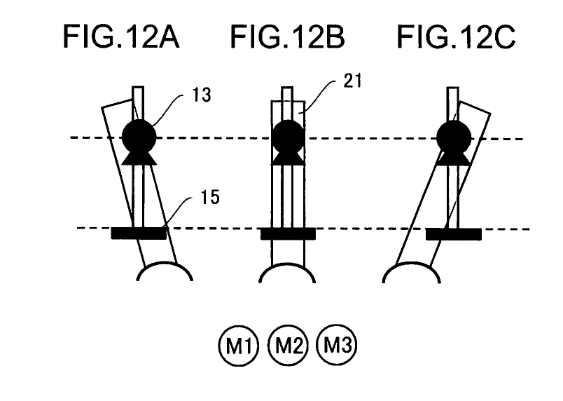

The attitude control buttons 65p and 65m illustrated in FIG. 6 are buttons for the horizontal movement in the longitudinal direction of the recumbent subject which has been described in the first embodiment. When the button 65m is depressed, the universal stand 10 is horizontally moved to the left as illustrated in FIG. 12A from the position of FIG. 12B. When the button 65p is depressed, the universal stand 10 is horizontally moved to the right as illustrated in FIG. 12C. At this time, the horizontal movement is accomplished with the relative positional relationship, i.e., SID or rotation angle between the X-ray tube unit 13 and X-ray detection unit 15 maintained. The depression of the buttons 65p and 65m causes the stand controller 11 to control the motors M1, M2, and M3.

The preset button group 66 is a button group for realizing an auto-positioning function. That is, several attitudes of the universal stand 10 frequently used in the inspection are registered to the buttons of the preset button group 66, respectively, through teaching of the trajectories of the movement of the universal stand 10 using the attitude control buttons 62 to 65. Thus, simply depressing each button of the preset button group 66 allows a predetermined attitude to be assumed. For example, the attitude pattern is registered according to radiographing direction, such that upright radiography of chest is registered to a button 0 and recumbent radiography of chest is registered to a button 1. Alternatively, the attitude pattern is registered according to the parts to be radiographed such as head, shoulder, and extremities, which allows quick control of the attitude or height of the stand. Further alternatively, the oblique incidence radiography, etc., described in the second embodiment may be registered. In the case where there is no need of the teaching, it is possible to achieve the ultimate target position based on a previously calculated rotation amount of each motor.

As described above, according to the third embodiment, the doctor can easily remotely control the attitude of the universal stand 10 while performing the endoscopic inspection.

### Fourth Embodiment

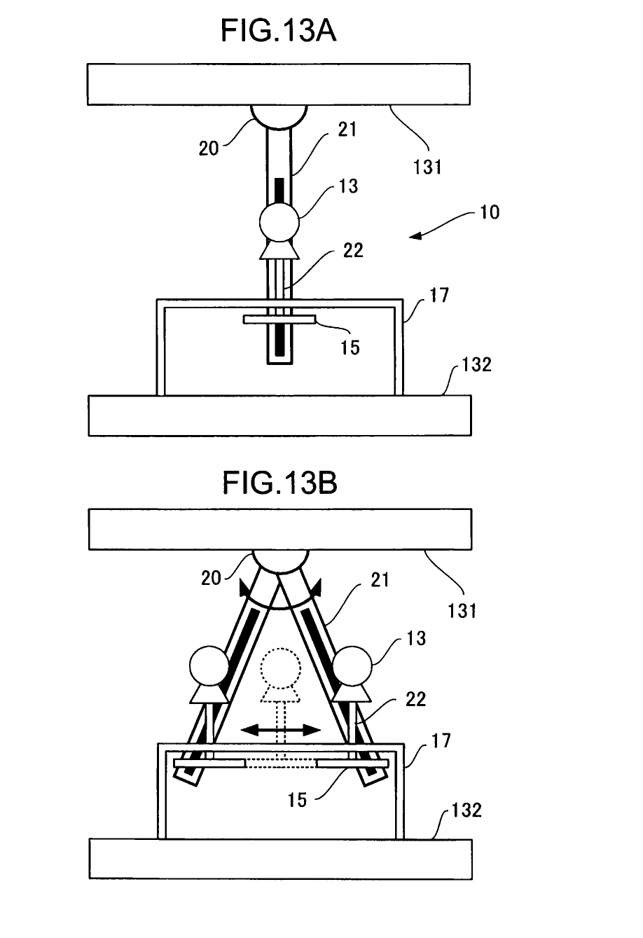

In the embodiments described above, a case where the universal stand 10 is installed on the floor surface is described; while in the present embodiment, the universal stand 10 is installed on the ceiling surface. FIG. 13A illustrates a reference position at which the longitudinal axes of the column 21 and arm 22 of the universal stand 10 are perpendicular to the ceiling surface, and FIG. 13B illustrates a state where the column is inclined relative to the reference position. The configurations of the X-ray imaging apparatus, universal stand, stand operation unit, and the like are the same as those of the above embodiments. However, the diameters of the column 21 and the like are slightly different depending on a condition such as the height of the ceiling and weight of the apparatus.

In the state illustrated in FIG. 13A, the inclining unit 20 of a ceiling-mount type universal stand is fixed to a ceiling surface 131 through a not illustrated holding unit, and the column 21 and arm 22 are so controlled that the longitudinal axes of the column 21 and arm 22 are perpendicular to the ceiling surface 131.

The X-ray tube unit 13 mounted to the arm 22 is situated above the table 17, and the X-ray detection unit 15 mounted to the arm 22 so as to be opposed to the X-ray tube unit 13 is set to a predetermined position below the table 17.

In FIG. 13B, the column 21 is inclined relative to the reference position illustrated in FIG. 13A to perform horizontal movement in the longitudinal direction of the recumbent subject (left-right direction in the drawing) with the relative positional relationship between the X-ray tube unit 13 and X-ray detection unit 15 maintained. Also in the present embodiment, the controlling values for the horizontal movement may be calculated according to FIG. 3 and horizontal movement control expressions (1) to (6).

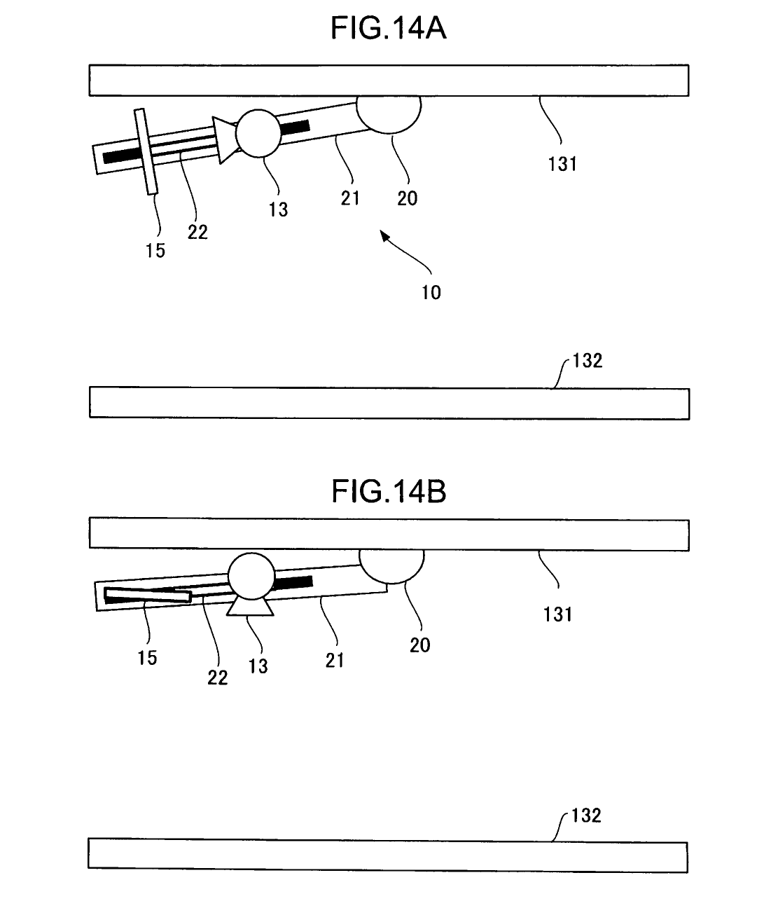

FIGS. 14A and 14B illustrate a case where the column is moved to a retracted position when the universal stand is not in use. When the universal stand is not in use, the column 21 is moved to a position near the ceiling, thereby ensuring a working space. The state illustrated in FIG. 14A can be achieved simply by inclining the column 21 from the reference position illustrated in FIG. 13A. In this case, a time required for restarting the operation is short, and is thus effective in the case where frequent radiography is needed.

Specifically, the motor M3 and motor M1 are controlled to move the arm 22 and column 21 to a position at which the longitudinal axes thereof are perpendicular to the ceiling surface 131 to set the universal stand 10 to the reference position illustrated in FIG. 13A once, and then the motor M1 of the inclining unit 20 is controlled to move the column 21 to the position near the ceiling surface 131.

In the case where the column 21 needs to be moved immediately to the retracted position in a state where the column 21 is inclined after the horizontal movement in the longitudinal direction of the recumbent subject (left-right direction in the drawing) as illustrated in FIG. 13B, the universal stand 10 is not set to the reference position illustrated in FIG. 13A but directly the inclination angle of the column 21 is increased in the direction toward the ceiling surface 131, thereby reducing a time required for the column to be moved to the retracted position. In this case, in order to obtain the inclination angle of the column 21, the positions of the individual components are calculated so that the X-ray tube unit 13 and the like do not contact the ceiling surface 131. Further, the rotation angle of the arm 22 may be set to an optimum value so that the X-ray tube unit 13 or X-ray detection unit 15 does not contact the ceiling surface 131 in association with the inclination of the column 21.

FIG. 14B illustrates a column retraction method taken in the case where the universal stand 10 is not used for comparatively a long time. In this case, the universal stand 10 can be retracted in a compact manner, ensuring a wider working space. In the case where the X-ray tube unit 13 or X-ray detection unit of the universal stand 10 is provided with a rotation mechanism, control of the rotation angle of the X-ray tube unit 13 or X-ray detection unit 15 allows the column 21 to be inclined to a position nearer to the ceiling surface 131 as compared to the case of FIG. 14A, thereby ensuring a wider working space.

Specifically, the motor M3 and motor M1 are controlled to move the arm 22 and column 21 to a position at which the longitudinal axes thereof are perpendicular to the ceiling surface 131 to set the universal stand 10 to the reference position illustrated in FIG. 13A once, and then the motor M1 of the inclining unit 20 is controlled to move the column 21 to a position near the ceiling surface 131. Further, at the same time, the motor M5 or motor M6 is controlled to control the angle of the X-ray tube unit 13 or X-ray detection unit 15 to move the column 21 as close as possible to the ceiling surface 131.

Also in this case, it is possible to directly incline the column 21 in the direction toward the ceiling surface 131 to move the column 21 to the retracted position without setting back the universal stand 10 to the reference position illustrated in FIG. 13A. The retraction of the column can be controlled through the stand operation unit 12. In the case where the arm 22 has a bending portion like “C”, the column 21 is inclined to such a direction that a convex portion of the bending portion faces the floor surface 132. This allows the column 21 to be inclined near the ceiling surface 131.

As described above, according to the fourth embodiment, the installation of the universal stand to the ceiling provides a wide working space on the floor surface, making it easily to arrange other medical instruments. Further, the universal stand 10 can be retracted to the ceiling portion when not in use, ensuring the working space and improving accessibility. Further, a guide rail and the like, which is required in the conventional approach, need not be laid.

Therefore, according to the universal stand of the above present embodiments of the present invention, it is possible to horizontally move the X-ray tube unit and X-ray detection unit without moving the patient and to reduce the installation area of the X-ray imaging apparatus. This improves accessibility and workability and maximizing the space.

The present invention is not limited to the above embodiments but various modifications may be made thereto. For example, the operation panel may be provided with not only the joystick and buttons but also various user interfaces such as a touch panel in the above respective embodiments.

Further, although a description has been made of the horizontal movement in the longitudinal direction of the recumbent subject which is used very often, it is possible to employ a configuration in which a motor capable of achieving movement in the lateral direction of the recumbent subject (direction perpendicular to the body axis) is added to perform the horizontal movement in the lateral direction of the recumbent subject simultaneously with the longitudinal direction of the recumbent subject.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An X-ray imaging apparatus comprising:
an arm unit holding an X-ray tube unit that generates an X-ray and an X-ray detection unit that detects the X-ray generated by the X-ray tube unit;
a column unit rotatably supporting the arm unit;
a holding unit holding the column unit at a floor surface;
an inclining unit inclining the column unit with the holding unit as a rotation center axis thereof; and
a controller performing control, when the column unit is inclined by the inclining unit, to horizontally move the X-ray tube unit and X-ray detection unit while maintaining the relative distance and relative angle therebetween.

2. The apparatus according to claim 1, wherein
the inclining unit has a first motor capable of inclining the column unit at a predetermined angle,
the column unit has a second motor capable of linearly moving the arm unit along the longitudinal direction of the column unit and a third motor capable of rotating the arm unit at a predetermined angle.

3. The apparatus according to claim 2, wherein
the arm unit has a fourth motor capable of linearly moving the X-ray tube unit in the longitudinal direction of the arm unit, a fifth motor capable of rotating the X-ray tube unit at a predetermined angle, and a sixth motor capable of rotating the X-ray detection unit at a predetermined angle.

4. The apparatus according to claim 3, wherein
the X-ray detection unit has an FPD or an FPD with a grid detachably attached thereto.

5. The apparatus according to claim 4, wherein
the X-ray tube unit has an X-ray tube and an X-ray diaphragm.

6. The apparatus according to claim 5, further comprising an operation unit connected to the controller and is used for operating the controller.

7. The apparatus according to claim 6, wherein
the operation unit has a user interface for performing attitude control operation including vertical movement and rotational movement of the arm, rotational movement of the X-ray tube unit, rotational movement of the X-ray detection unit, SID operation to change the distance between the X-ray tube and FPD, and horizontal movement of the arm.

8. The apparatus according to claim 7, wherein
the operation unit is connected wired or wireless to the controller.

9. The apparatus according to claim 1, wherein
the inclining unit has a first motor capable of inclining the column unit at a predetermined angle,
the column unit has a second motor capable of linearly moving the arm unit along the longitudinal direction of the column unit and a third motor capable of rotating the arm unit at a predetermined angle.

10. The apparatus according to claim 9, wherein
the X-ray detection unit has an FPD or an FPD with a grid detachably attached thereto.

11. The apparatus according to claim 10, wherein
the X-ray tube unit has an X-ray tube and an X-ray diaphragm.

12. The apparatus according to claim 11, further comprising an operation unit connected to the controller and is used for operating the controller.

13. The apparatus according to claim 12, wherein
the operation unit has a user interface for performing attitude control operation including vertical movement and rotational movement of the arm, rotational movement of the X-ray tube unit, rotational movement of the X-ray detection unit, SID operation to change the distance between the X-ray tube and FPD, and horizontal movement of the arm.

14. The apparatus according to claim 13, wherein
the operation unit is connected wired or wireless to the controller.

15. An X-ray imaging apparatus comprising:
an arm unit holding an X-ray tube unit that generates an X-ray and an X-ray detection unit that detects the X-ray generated by the X-ray tube unit;
a column unit rotatably supporting the arm unit;
a holding unit holding the column unit at a ceiling surface;
an inclining unit inclining the column unit with the holding unit as a rotation center axis thereof; and
a controller performing control, when the column unit is inclined by the inclining unit, to horizontally move the X-ray tube unit and X-ray detection unit while maintaining the relative distance and relative angle therebetween.

16. The apparatus according to claim 15, wherein
the inclining unit has a first motor capable of inclining the column unit at a predetermined angle,
the column unit has a second motor capable of linearly moving the arm unit along the longitudinal direction of the column unit and a third motor capable of rotating the arm unit at a predetermined angle.

17. The apparatus according to claim 16, wherein
the inclining unit is controlled to move the column unit to a position near the ceiling surface.

18. The apparatus according to claim 17, wherein
the arm unit has a fourth motor capable of linearly moving the X-ray tube unit in the longitudinal direction of the arm unit, a fifth motor capable of rotating the X-ray tube unit at a predetermined angle, and a sixth motor capable of rotating the X-ray detection unit at a predetermined angle.

19. The apparatus according to claim 18, wherein
the inclining unit is controlled to move the column unit to a position near the ceiling surface, and the angle of the X-ray tube unit or X-ray detection unit is controlled.
